(19) United States
(12) Patent Application Publication
(10) Pub. No.: US 2017/0211934 A1
(43) Pub. Date: Jul. 27, 2017

(54) DIGITAL GEOLOGIC COMPASS/INCLINOMETER SYSTEM AND METHOD

(71) Applicant: Board of Regents, The University of Texas System, Austin, TX (US)

(72) Inventors: Terry L. Pavlis, El Paso, TX (US); Edgar Bustamante, El Paso, TX (US); Carlos O. Gomez Hernandez, El Paso, TX (US); Noel P. Martinez, El Paso, TX (US)

(21) Appl. No.: 15/414,861

(22) Filed: Jan. 25, 2017

Related U.S. Application Data
(60) Provisional application No. 62/287,008, filed on Jan. 26, 2016.

(51) Int. Cl. G01C 17/02

(52) U.S. Cl. CPC G01C 17/02

(57) ABSTRACT

A digital geologic compass system includes a microcontroller electronically connected with an accelerometer, a gyroscope, and a magnetometer, which facilitates operations of the accelerometer, the gyroscope, and the magnetometer and data output from the accelerometer, the gyroscope, and the magnetometer. The digital geologic compass system further includes a GPS (Global Positioning System) unit that communicates with the microcontroller, wherein the microcontroller facilitates an operation of the GPS unit. Additionally, a digital display receives data output from the microcontroller and which is subject to control by the microcontroller. A communications interface is displayable via the digital display. A power supply also provides power to the microcontroller.

### CROSS-REFERENCE TO PROVISIONAL APPLICATION

This nonprovisional patent application claims the benefit under 35 U.S.C. §119(e) and priority to U.S. Provisional Patent Application Ser. No. 62/287,008 filed on Jan. 26, 2016, entitled “Digital Geologic Compass/Inclinometer System and Method,” which is hereby incorporated herein by reference in its entirety.

### TECHNICAL FIELD

Embodiments are related to digital geologic compass devices, systems, and methods. Embodiments also relate to inclinometers and electronic and data-processing components such as processors and microcontrollers. Embodiments additionally relate to accelerometers, gyroscopes, and magnetometers.

### BACKGROUND

The conventional, portable magnetic compass has several shortcomings inherent in its principle of operation. Every such instrument senses the earth's magnetic field lines by means of a magnetic element that orients itself to such lines. However, in certain environments as, for example, underground, where steel structures and magnetic rock may be found, a magnetic compass will not work. The standard of accuracy for magnetic compasses is the Brunton magnetic compass. However, a magnetic compass requires an environment where the earth's magnetic field is not severely interdicted by local influences.

Devices currently used by geologists are analog devices. Two types of devices are typically used, but neither is adequate for the general needs of field geology. The most common devices use sensor(s) in a cell phone and a companion application developed to use these devices. However, sensor quality in these devices is poor and results are unreliable. A higher end device is built in Japan by a GS and is called “GeoClino”. The cost of this device is sufficiently high, and prevents its widespread use.

Thus, there is a need for additional devices that function as a Geologist's compass and inclinometer.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for a digital geologic compass system, device, and method.

It is another aspect of the disclosed embodiments to provide for a digital geological inclinometer.

The aforementioned aspects and other objectives and advantages can now be achieved as described herein. A digital geologic compass system and method thereof are disclosed. In an example embodiment, the digital geologic compass system includes a microcontroller electronically connected with an accelerometer, a gyroscope, and a magnetometer, which facilitates operations of the accelerometer, the gyroscope, and the magnetometer, and data output from the accelerometer, the gyroscope, and the magnetometer. The digital geologic compass system can further include a GPS (Global Positioning System) unit that communicates with the microcontroller, wherein the microcontroller facilitates an operation of the GPS unit. Additionally, a digital display receives data output from the microcontroller and which is subject to control by the microcontroller. A communications interface is displayable via the digital display. A power supply also provides power to the microcontroller.

The communications interface can support wireless communication, which in some embodiments may include wireless communication comprised of UHF radio waves in an SM band between 2.4 GHz to 2.485 GHz (e.g., Bluetooth® wireless communications). In another example embodiment such wireless communication may involve cellular communications. In yet another example embodiment, such wireless communication may involve Wi-Fi (e.g., WLAN) communications.

In some example embodiments, a portable computing device can communicate with the geologic compass system. The portable computing device can be configured to receive the data from the geologic compass system and process the data utilizing a mapping application.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a block diagram of a digital geologic compass/inclinometer system, which can be implemented in accordance with an example embodiment;

FIG. 2 illustrates a block diagram of a digital geologic compass/inclinometer system, in accordance with another example embodiment;

FIG. 3 illustrates a block diagram of a digital geologic compass/inclinometer system, in accordance with another example embodiment;

FIG. 4 illustrates a block diagram of a network configuration in which a digital geologic compass/inclinometer system can communicate with one or more servers and one or more client devices via a wireless communications network, in accordance with an example embodiment;

FIG. 5 illustrates a flow-chart of operations depicting logical operational steps of a method for creating a topographic map, in accordance with an example embodiment;

FIG. 6 illustrates a schematic view of a computer system, in accordance with an example embodiment; and

FIG. 7 illustrates a schematic view of a software system including a unit, an operating system, and a user interface, in accordance with an example embodiment.

### DETAILED DESCRIPTION

The particular values and configurations discussed in these non-limiting examples can be varied and are cited merely to illustrate at least one embodiment and are not intended to limit the scope thereof.

The example embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to identical, like, or similar elements throughout, although such numbers may be referenced in the context of different embodiments. As used herein, the term “and/or” includes any and all combinations of one or more of the associated listed items.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A digital geologic compass system is disclosed, which includes a microcontroller electronically connected with an accelerometer, a gyroscope, and a magnetometer, which facilitates operations of the accelerometer, the gyroscope, and the magnetometer and data output from the accelerometer, the gyroscope, and the magnetometer. The digital geologic compass system further includes a GPS (Global Positioning System) unit that communicates with the microcontroller, wherein the microcontroller facilitates an operation of the GPS unit. Additionally, a digital display receives data output from the microcontroller and which is subject to control by the microcontroller. A communications interface is displayable via the digital display. A power supply also provides power to the microcontroller.

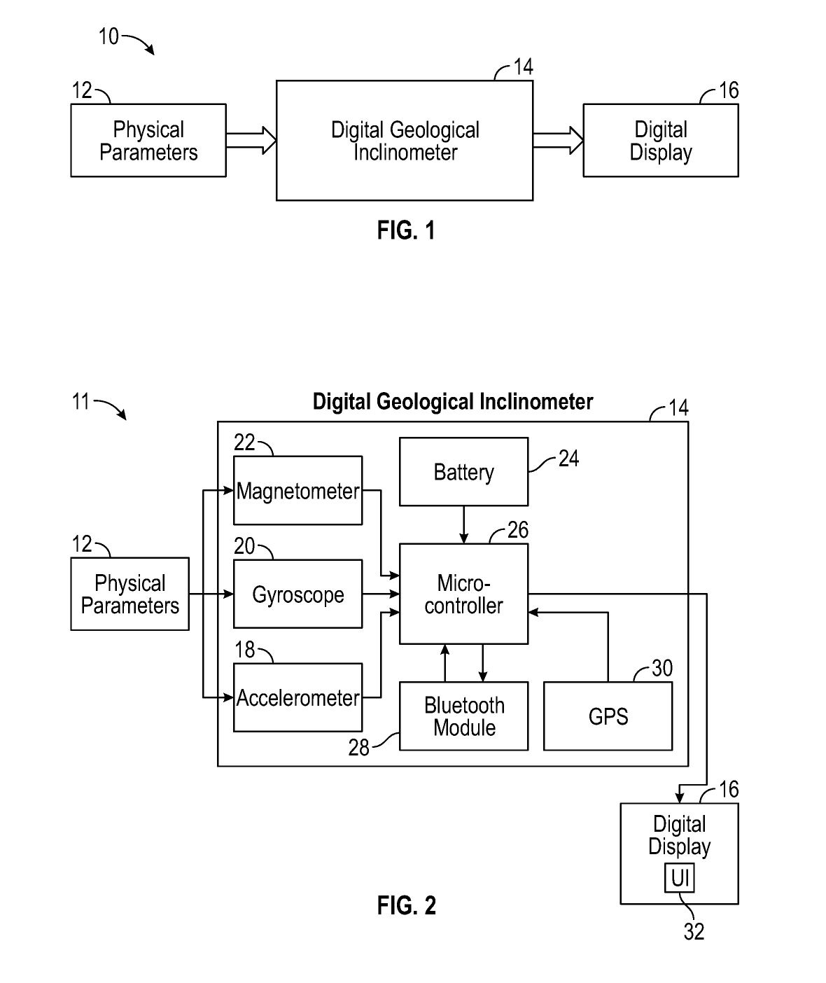

FIG. 1 illustrates a block diagram of a digital geologic compass/inclinometer system 10, which can be implemented in accordance with an example embodiment. As depicted in FIG. 1, the system 10 includes a digital geological inclinometer 14 that receives as input physical parameters 12 and outputs data for display via a digital display 16. The system 10 can implement a digital geologic compass that measures a plane in three-dimensional space, that is, an azimuth angle and an angle of inclination with respect to a horizontal plane normal to the direction of gravity.

Measurements of the direction and inclination of a normal surface in civil engineering works, measurements of direction and inclination of items such as pillars and floors in construction works, and measurements of deformation of pillars and floors in house investigations are performed by human labor with an exercise of precise surveying techniques as will be described later. In some example embodiments, a method of measuring the azimuth angle of a discontinuous surface of stratum in geological investigations (the so-called “strike” in the field of geology) and the angle of inclination (the so-called “dip” in geology) can be implemented in the context of a mechanical inclinometer as will be described later herein.

FIG. 2 illustrates a block diagram of a digital geologic compass/inclinometer system 11 in accordance with another example embodiment. Note that like parts or elements are generally indicated by identical reference numerals in FIGS. 1-2. System 11 can be implemented as a digital geologic compass device. System 11 generally includes the digital geological inclinometer 14 shown in FIG. 1, but is shown in more detail in the example embodiment depicted in FIG. 2. In some embodiments, the digital geological inclinometer 14 can be configured to include a magnetometer 22 (e.g., a compass) that communicates electronically with a microcontroller 26, a gyroscope 20, and an accelerometer 18.

The magnetometer 22 can be configured as a measurement instrument that measures the magnetization of a magnetic material such as for example, a ferromagnet, or measures the strength and, in some cases, the direction of the magnetic field at a point in space. The accelerometer 18 can be implemented as an electromechanical device that measures acceleration forces. The gyroscope 20 can he implemented as a spinning wheel or disc in which the axis of rotation is free to assume any orientation. When rotating, the orientation of this axis is unaffected by tilting or rotation of the mounting, according to the conservation of angular momentum.

In some example embodiments, system 11 can be configured to interface with an open source program such as QGIS. QGIS (previously known as “Quantum GIS”) is an example of a cross-platform free and open-source desktop geographic information system (GIS) application that provides data viewing, editing, and analysis. Thus, with the embodiments shown herein, data can be sent to QGIS to fill attribute fields used in geologic mapping and is configured to interface directly to a field GIS system. Specific fields are orientation information for planes (strike and dip) and lines (trend and plunge)

The magnetometer 22, the gyroscope 20, and the accelerometer 18 receive physical parameters 12 in the form of electronic/signals. The digital display 16 can display a UI (User Interface) 32. In some embodiments, the device or system 11 can be configured to communicate with a second device or system, computer system. In a further aspect, the second device can be a portable computing device such as a field tablet computer.

Data can be output from the magnetometer 22, the gyroscope 20, and the accelerometer 18 and provided as input to the microcontroller 26, which is powered by a battery 24 and communicates electronically and bidirectionally with a Bluetooth® unit 28 and a GPS (Global Positioning Satellite) unit 30. Note that as utilized herein, the term Bluetooth® refers generally to a wireless technology standard for exchanging data over short distances (e.g., using short-wavelength UHF radio waves in the ISM band from 2.4 to 2.485 GHz) from fixed and mobile devices. The Bluetooth® standard is managed by the Bluetooth Special Interest Group (SIG). It can be appreciated that other wireless communications standards may be implemented in place of or in addition to the Bluetooth® unit 28, which is illustrated in FIG. 2 for exemplary purposes only.

The microcontroller 26 can be implemented in some example embodiments as a small computer (SoC) on a single integrated circuit containing a processor core, memory, and programmable input/output peripherals. Program memory in the form of Ferroelectric RAM, NOR flash, or OTP ROM can also be included on a chip in some embodiments, as well as a typically small amount of RAM. The microcontroller 26 can be configured to facilitate the operation of the various components associated with the digital geological inclinometer 14, such as, for example, the magnetometer 22, the gyroscope 20, the accelerometer 18, the battery 24, the Bluetooth® unit 28, the GPS unit 30, and the digital display 16 and user interface 32.

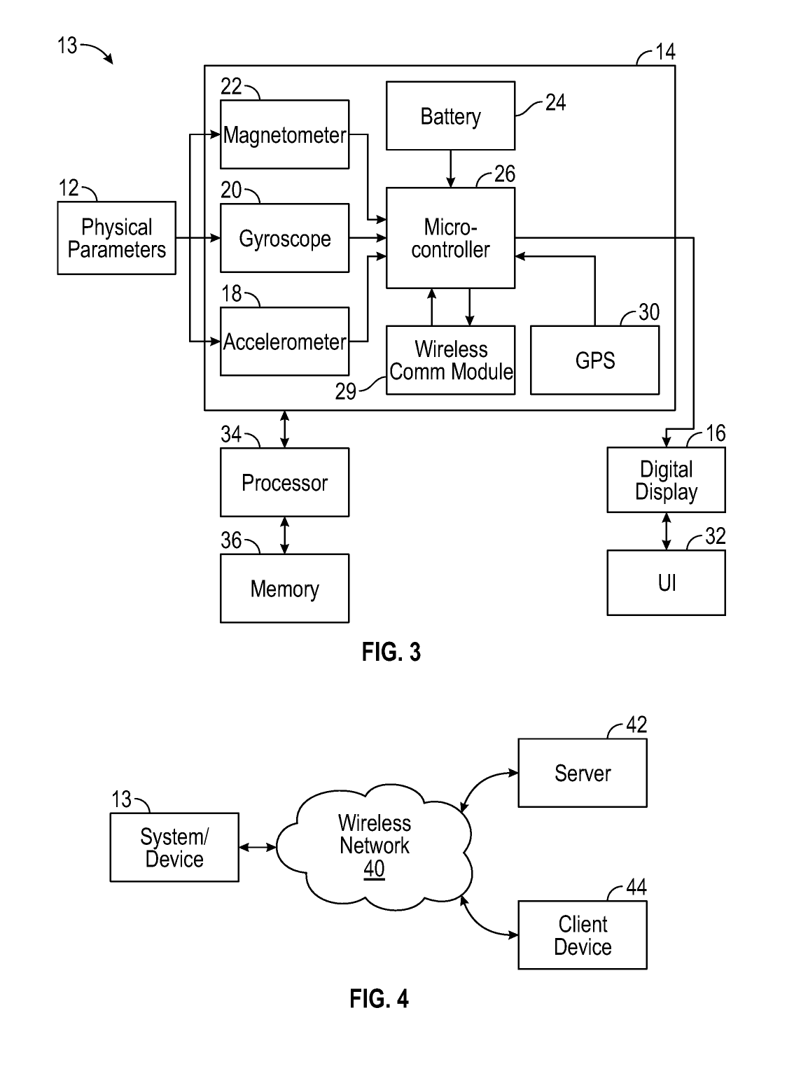

FIG. 3 illustrates a block diagram of a digital geologic compass/inclinometer system 13, in accordance with another example embodiment. Note that like or similar parts or elements are indicated generally by identical reference numerals in FIGS. 1-3. Thus, the example embodiment of system 13 shown in FIG. 3 is similar to the embodiments shown in FIGS. 1-2, but with some minor differences.

The sensor 12 may be connected electronically to the digital geological inclinometer 14 or can provide data to the digital geological inclinometer 14 via wireless communications (e.g., cellular communications means, Wi-Fi, Bluetooth® wireless communications means, and so on). As shown in FIG. 3, a wireless communications unit 29 may be implemented in place of the Bluetooth® unit 28 shown in FIG. 2. Note that the term “Wi-Fi” as utilized herein refers generally to a local area wireless computer networking technology that allows electronic devices to connect to a wireless network using 2.4 Gigahertz (12 cm) UHF and 5 Gigahertz (6 cm) SHE ISM radio bands. “Wi-Fi” includes any “wireless local area network” (WLAN) product based on the IEEE 802.11 standards. The term “Wi-Fi” as utilized herein is also a synonym for “WLAN” (Wireless Local Area Network) since most WLANs are based on these standards. “Wi-Fi” is a trademark of the Wi-Fi Alliance.

The wireless communications module 29 may facilitate wireless communications such as, for example, Wi-Fi communications, cellular communications, and so on. A processor 34 also communicates electronically with a memory 36 and can process instructions stored in memory 38, which can direct the interactions among components such as, for example, the magnetometer 22, the gyroscope 20, the accelerometer 18, the microcontroller 26, the wireless communications module 29, the GPS module 30, the digital display 16, the user interface 32, and so on.

FIG. 4 illustrates a block diagram of a network configuration in which a digital geologic compass/inclinometer system such as the system 13 (or systems 10, 11) can communicate with one or more servers such as server 42 and one or more client devices such as client device 44 via a wireless communications network 40, in accordance with an example embodiment.

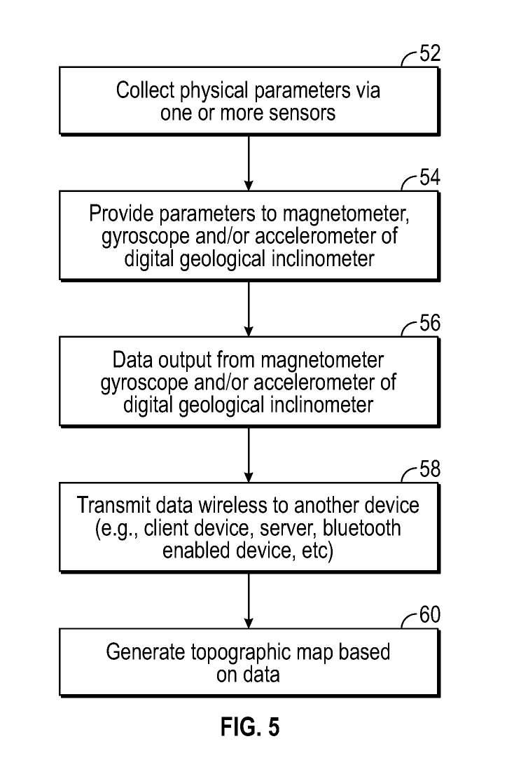

FIG. 5 illustrates a flow-chart of operations depicting logical operational steps of a method for creating a topographic map, in accordance with an example embodiment. As indicated at block 52, physical parameters are collected via a magnetometer, a gyroscope, and/or an accelerometer of a digital geological inclinometer such as the inclinometer 14, as indicated at block 54. As illustrated thereafter at block 56, data is electronically output from the magnetometer, the gyroscope, and/or the accelerometer, and then as indicated at block 58, transmitted wirelessly (e.g., cellular communications means, Wi-Fi Bluetooth® wireless communications means) to another device such as, for example a client device 44 or server 42 or a Bluetooth® wireless communications.

In the case of Bluetooth® wireless communications, the wireless transmission of the data generated by the magnetometer, the gyroscope, and the accelerometer may be wirelessly transmitted directly to the other device. In the case of cellular or Wi-Fi communications, such data may be transmitted via, for example, a wireless network such as the wireless network 40 shown in FIG. 4. The second device, which may be the client device 44 or server 42 can include a software package for processing the data generated by the magnetometer, the gyroscope, and the accelerometer into a topographic map, as shown at block 60.

Such an approach allows for the creation of a topographic map utilizing a software package that creates topographic maps of regions. Currently, the competition only measures plane and line type characteristics and stores these measurements in the devices' internal memory. The disclosed embodiments, however, provide for a device that can transmit this data to a computer equipped with such a software package via USB and Bluetooth as geologists take measurements. This will allow geologists to have their topographic maps finished when they are done taking measurements. Thus, wireless communication and USB create topographic maps with the digital geological inclinometer.

Note that in some embodiments, computer program code for carrying out operations of the disclosed embodiments may be written in an object oriented programming language (e.g., Java, C#, C++, etc.). Such computer program code, however, for carrying out operations of particular embodiments can also be written in conventional procedural programming languages, such as the “C” programming language or in a visually oriented programming environment, such as, for example, Visual Basic.

The program code may execute entirely on, the user's, computer, partly on the user's computer, as a stand-alone software package, partly on the user's computer and partly on a remote computer, or entirely on the remote computer. In the latter scenario, the remote computer may be connected to a user's computer through a local area network (LAN) or a wide area network (WAN), wireless data network e.g., WiMAX, 802.xx, and cellular network, or the connection may be made to an external computer via most third party supported networks (e.g., through the Internet via an Internet Service Provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the various block or blocks, flowcharts, and other architecture illustrated and described herein.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

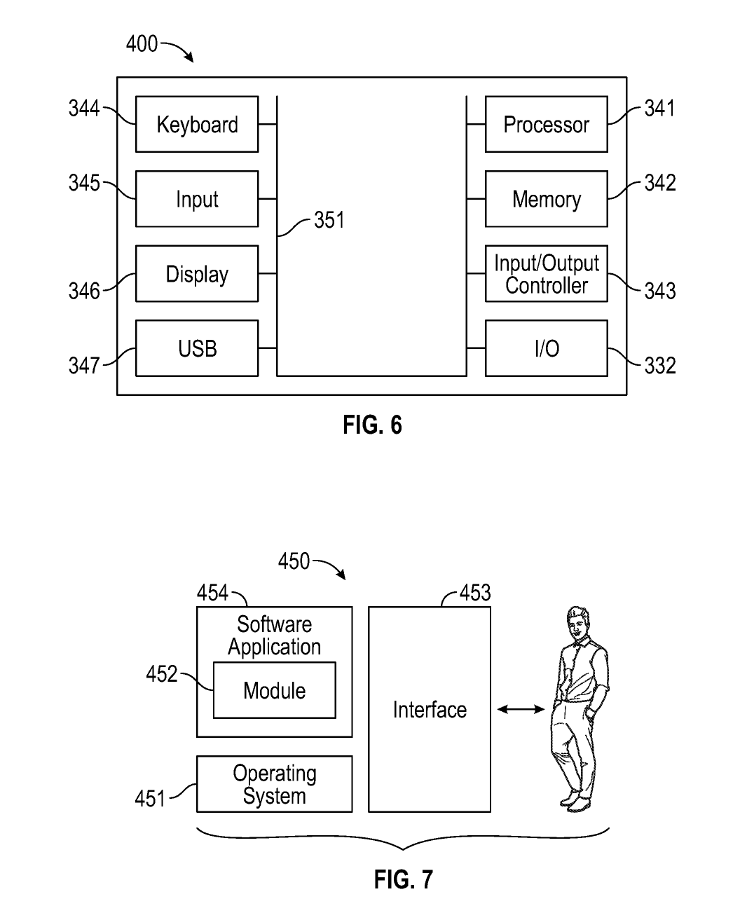

FIGS. 6-7 are shown only as exemplary diagrams of data-processing environments in which embodiments may be implemented. It should be appreciated that FIGS. 6-7 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 6, some embodiments may be implemented in the context of a data-processing system 400 that can include one or more processors such as processor 341, a memory 342, a controller 343 (e.g., an input/output controller), a USB (Universal Serial. Bus) connection 347, a keyboard 344 (e.g., a physical keyboard or a touchscreen graphically displayed keyboard), an input component 345 (e.g., a pointing device, such as a mouse, track ball, pen device, which may be utilized in association or with the keyboard 344, etc.), a display 346, and another peripheral device (not shown). An I/O interface 332 may also be included with system 400.

In some example embodiments, data-processing system 400 may be, for example, a client-computing device (e.g., a client PC, laptop, tablet computing device, etc.), which communicates with other devices (not shown) via a client-server network (e.g., wireless and/or wired), wherein such devices communicate with the client-computing device via a computing network. In other example embodiments, the data-processing system 400 may function as a server in the context of a client-server computing network. Thus, in some embodiments, system 400 can function as, for example, the server 42 or the client device 44 shown in FIG. 4. In other embodiments, system 400 can function as, for example, the device or systems 10, 1 13, respectively shown in FIGS. 1, 2, and 3 herein.

As illustrated, the various components of data-processing system 400 can communicate electronically through a system bus 351 or similar architecture. The system bus 351 may be, for example, a subsystem that transfers data between, for example, computer components within data-processing system 400 or to and from other data-processing devices components, computers, etc. Data-processing system 400 may be implemented as, for example, a server in a client-server based network (e.g., the Internet) or can be implemented in the context of a client and a server (i.e., where aspects are practiced on the client and the server). Data-processing system 400 may be, for example, a standalone desktop computer, a laptop computer, a Smartphone, a pad computing device, a server, and so on.

FIG. 7 illustrates a computer software system 450 for directing the operation of the data-processing system 400 shown in FIG. 6. Software application 454 stored, for example, in memory 342, generally includes a kernel or operating system 451 and a shell or interface 453. One or more application programs, such as software application 454, may be “loaded” (i.e., transferred from, for example, memory 342 or another memory location) for execution by the data-processing system 400. The data-processing system 400 can receive user commands and data through the interface 453; these inputs may then be acted upon by the data-processing system 400 in accordance with instructions from operating system 451 and/or software application 454. The interface 453, in some embodiments, can serve to display results, whereupon a user may supply additional inputs or terminate a session.

The software application 454 can include one or more modules such as module 452, which can, for example, implement instructions or operations such as those described herein. Examples of instructions that can be implemented by module 452 include steps or operations such as those shown and described herein with respect to blocks 52, 54 56, 58, and 60 of FIG. 5 and described elsewhere herein.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” constitutes a software application. However, a module may also be composed of, for example, electronic and/or computer hardware or such hardware in combination with software. In some cases, a “module” can also constitute a database and/or electronic hardware and software that interact with the database.

Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

A “module” can also be composed of other modules or sub-modules. Thus, the instructions or steps such as those shown in FIG. 5 and discussed elsewhere herein can be implemented in the context of such a module, modules, sub-modules, and so on. In other embodiments, the term module may refer to a hardware component such as, for example, the wireless communications module 29 or GPS module 30 shown in FIG. 3. In yet other embodiments, the wireless communications module 29 and GPS module 30 may be composed of both a software module such as module 452 shown in FIG. 7 and/or an electronic hardware module, depending upon design considerations.

A memory such as memory 342 shown in FIG. 6 or memory 36 of FIG. 3 may include program instructions (e.g., a module) configured to implement certain embodiments described herein, and data storage comprising various data accessible by the program instructions. The program instructions may include software elements of embodiments described herein. For example, program instructions may be implemented in various embodiments using any desired programming language, scripting language, or combination of programming languages and/or scripting languages (e.g., C, C++, C#, JAVASCRIPT®, PERL®, etc.). Data storage may include data that may be used in these embodiments. In other embodiments, other or different software elements and data may be included. These software objects will include links to the open source program QGIS to feed data into attribute fields of the GIS system.

FIGS. 6-7 are intended as examples and not as architectural limitations of disclosed embodiments. Additionally, such embodiments are not limited to any particular application or computing or data processing environment. Instead, those skilled in the art will appreciate that the disclosed approach may be advantageously applied to a variety of systems and application software. Moreover, the disclosed embodiments can be embodied on a variety of different computing platforms, including, for example, Windows, Macintosh, UNIX, LINUX, and the like.

The data-processing system 400 (e.g., computer system) can include one or more processors such as processor 341 coupled to a system memory via an input/output (I/O) interface. Such a data processing or, computer system 400 can further include a network interface coupled to I/O interface, and one or more input/output devices, such as a touch screen, a cursor control device, keyboard 344, and display 346. In certain aspects the system may comprise multiple nodes making up the system and different parts of the system may be configured to host different portions or instances of the methods or systems described herein.

In various embodiments, system 400 may be a single-processor system including one processor, or a multi-processor system including two or more processors (e.g., two, four, eight, or another suitable number). Processors may be any processor capable of executing program instructions. For example, in various embodiments, processors may be general-purpose or embedded processors implementing any of a variety of instruction set architectures (ISAs), such as the x86, POWERPC®, ARM®, SPARC®, or MIPS® ISAs, or any other suitable ISA. In multi-processor systems, each of processors may commonly, but not necessarily, implement the same ISA. Also, in some embodiments, at least one processor may be a graphics-processing unit (GPU) or other dedicated graphics-rendering device.

The system memory such as memory 342 may be configured to store program instructions and/or data accessible by processor. In various embodiments, system memory 342 may be implemented using any suitable memory technology, such as static random access memory (SRAM), synchronous dynamic RAM (SDRAM), nonvolatile/Flash-type memory, or any other type of memory. Program instructions and data implementing certain operations, such as, for example, those described herein, may be stored within system memory as program instructions and data storage, respectively.

In other embodiments, program instructions and/or data may be received, sent, or stored upon different types of computer-accessible media or on similar media separate from system memory or computer system. Generally speaking, a computer-accessible medium may include any tangible storage media or memory media such as magnetic or optical media—e.g., disk or CD/DVD-ROM coupled to computer system via the I/O interface 332. Program instructions and data stored on a tangible computer-accessible medium in non-transitory form may further be transmitted by transmission media or signals such as electrical, electromagnetic, or digital signals, which may be conveyed via a communication medium such as a network and/or a wireless link, such as may be implemented via network interface.

In an embodiment, I/O interface 332 may be configured to coordinate I/O traffic between processor, system memory, and any peripheral devices in the device, including network interface or other peripheral interfaces, such as input/output devices. In some embodiments, I/O interface 332 may perform any necessary protocol, timing, or other data transformations to convert data signals from one component (e.g., system memory) into a format suitable for use by another component (e.g., processor). In some embodiments, I/O interface may include support for devices attached through various types of peripheral buses, such as a variant of the Peripheral Component Interconnect (PCI) bus standard or the Universal Serial Bus (USB) standard, for example. In addition, in some embodiments some or all of the functionality of I/O interface 332, such as an interface to system memory 342, may be incorporated directly into a processor.

A network interface may be configured to allow data to be exchanged between the geologic device and other devices attached to a network, such as computer systems. In various embodiments a network interface may support communication via wired or wireless data networks, such as any suitable type of Ethernet network, for example: via telecommunications/telephony networks such as analog voice networks or digital fiber communications networks, via storage area networks such as Fiber Channel SANs, or via any other suitable type of network and/or protocol.

Input/output devices may, in some example embodiments, include one or more displays, keyboards, keypads, touch screens, scanning devices, voice or optical recognition devices, or any other devices suitable for entering or retrieving data by one or more system. Multiple input/output devices may be present in the system or may be distributed on various nodes of a system. In some embodiments, similar input/output devices may be separate from the system and may interact with one or more nodes of a system through a wired or wireless connection, such as over a network interface.

Based on the foregoing, it can be appreciated that a digital geologic compass system and method thereof can be implemented in accordance with various embodiments. In an example embodiment, the digital geologic compass system includes a microcontroller electronically connected with an accelerometer, a gyroscope, and a magnetometer, which facilitates operations of the accelerometer, the gyroscope, and the magnetometer and data output from the accelerometer, the gyroscope, and the magnetometer. The digital geologic compass system can further include a GPS (Global Positioning System) module that communicates with the microcontroller, wherein the microcontroller facilitates an operation of the GPS module. Additionally, a digital display receives data output from the microcontroller and which is subject to control by the microcontroller. A communications interface is displayable via the digital display. A power supply also provides power to the microcontroller.

The communications interface can support wireless communication, which in some embodiments may include wireless communication comprises UHF radio waves in an ISM band between 2.4 GHz to 2.485 GHz (e.g., Bluetooth® wireless communications). In another example embodiment, such wireless communication may involve cellular communications. In yet another example embodiment, such wireless communication may involve Wi-Fi (e.g., WLAN) communications. In still another example embodiment, such wireless communications may be facilitated by a combination of wireless formats or standards.

In some example embodiments, a portable computing device can communicate with the geologic compass system. The portable computing device can be configured to receive the data from the geologic compass system and process the data utilizing a mapping application.

It will, be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art, which are also intended to be encompassed by the following claims.

What is claimed is:

1. A digital geologic compass system, comprising:
a microcontroller electronically connected with an accelerometer, a gyroscope, and a magnetometer, which facilitates operations of said accelerometer, said gyroscope, and said magnetometer and data output from said accelerometer, said gyroscope, and said magnetometer;
a GPS (Global Positioning System) unit that communicates with said microcontroller, wherein said microcontroller facilitates an operation of said GPS unit;
a digital display that receives data output from said microcontroller and which is subject to control by said microcontroller;
a communications interface displayable via said digital display; and
a power supply that provides power to said microcontroller.

2. The system of claim 1 wherein said communications interface supports wireless communication.

3. The system of claim 2 wherein said wireless communication comprises UHF radio waves in an ISM hand between 2.4 GHz to 2.485 GHz.

4. The system of claim 2 wherein said wireless communication comprises cellular communication.

5. The system of claim 2 wherein said wireless communication comprises WiFi communication.

6. The system of claim 1 further comprising a portable computing device that communicates with said geologic compass system.

7. The system of claim 6 wherein said portable computing device is configured to receive said data from said geologic compass system and process said data utilizing a mapping application.

8. A digital, geologic compass system, comprising:
a microcontroller electronically connected with an accelerometer, a gyroscope, and a magnetometer, which facilitates operations of said accelerometer, said gyroscope, and said magnetometer and data output from said accelerometer, said gyroscope, and said magnetometer;
a GPS (Global Positioning System) unit that communicates with said microcontroller, wherein said microcontroller facilitates an operation of said GPS unit;
a digital display that receives data output from said microcontroller and which is subject to control by said microcontroller; and
a communications interface displayable via said digital display, wherein said communications interface supports wireless communication.

9. The system of claim 8 further comprising a power supply that provides power to said microcontroller.

10. The system of claim 8 wherein said wireless communication comprises UHF radio waves in an ISM band between 2.4 GHz to 2.485 GHz.

11. The system of claim 8 wherein said wireless communication comprises cellular communication.

12. The system of claim 8 wherein said wireless communication comprises WiFi communication.

13. The system of claim 8 further comprising a portable computing device that communicates with said geologic compass system.

14. The system of claim 13 wherein said portable computing device is configured to receive said data from said geologic compass system and process said data utilizing a mapping application.

15. A method of configuring a digital geologic compass system, said method comprising:
providing a microcontroller that is electronically connected with an accelerometer, a gyroscope, and a magnetometer, which facilitates operations of said accelerometer, said gyroscope, and said magnetometer and data output from said accelerometer, said gyroscope, and said magnetometer;
configuring a GPS (Global Positioning System) unit to communicate with said microcontroller, wherein said microcontroller facilitates an operation of said GPS unit;
providing a digital display that receives data output from said microcontroller and which is subject to control by said microcontroller;
configuring a communications interface displayable via said digital display; and
providing a power supply that supplies power to said microcontroller.

16. The method of claim 15 wherein said communications interface supports wireless communication.

17. The method of claim 16 wherein said wireless communication comprises UHF radio waves in an ISM band between 2.4 GHz to 2.485 GHz.

18. The method of claim 16 wherein said wireless communication comprises cellular communication.

19. The method of claim 16 wherein said wireless communication comprises WiFi communication.

20. The method of claim 15 further comprising providing a portable computing device that communicates with said geologic compass system, wherein said portable computing device is configured to receive said data from said geologic compass system and process said data utilizing a mapping application
